(19) United States
(12) Patent Application Publication
(10) Pub. No.: US 2004/0224645 A1
(43) Pub. Date: Nov. 11, 2004

(54) Phone handset with wireless technology

(76) Inventor: Liou Chih Ching, Chungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/430,184

(22) Filed: May 7, 2003

(51) Int. Cl. H04M 1/00

(52) U.S. Cl. 455/90.3; 455/575.1

(57) ABSTRACT

A phone handset with wireless technology applies to public telecommunications service equipment having a base, a spiral metal wire, and a Net-switching device comprises a handset body and an antenna having two ends, whereby the handset body is connected to the base of the public telecommunications service equipment by the spiral metal wire; one end of the antenna positioned in the handset body for receiving and emitting signals on wireless networks; and the other end thereof connected to the Net-switching device for transferring package information between the client wireless products. Therefore, the phone handset provides not only telephone calling and also Wireless Internet service. One object of the phone handset is achieved to omit manufacturing and setting steps thereof, lower costs by reducing the extra housing, and prevent destructions of wireless communication device from exposing thereof out of the base of the public telecommunications service equipment.

### BACKGROUND OF THE INVENTION

1. Field of the Invention

The present invention relates to a phone handset with wireless technology. More particularly, the present invention relates to a phone handset in applying to a public phone for Wireless Internet service.

2. Description of Related Art

Along with continual development of telecommunication technology, rapidly growth of portable electronic product and various kinds of propensity of consumers, the application of broadband network is much more commonly, and the possibility for Internet service in public provided by prevalent public telecommunications service equipment is in great request. The public telecommunications service equipment includes a public phone, an emergency phone, and interactive multi-media information station (such as KIOSK).

Prior art public telecommunications service equipment providing broadband network includes a public multi-media phone, an interactive multi-media information station, a public phone with a modem port, and a public phone with ADSL (Asymmetrical Digital Subscriber Line) providing Wireless Internet service.

A Wireless Local Area Network (wireless LAN) is also a developing communication for Internet service. The information of the wireless LAN is transferred in a backbone network composed of electric cable or optical fiber and delivered to a client by wireless technology. Wireless LAN includes a plurality of Access Point (AP), which segment partially overlaps to each other, to form certain communication coverage for connecting the client. Wireless standard includes technology such as Blue Tooth, IEEE 802.11 protocol, HYPERLAN and etc.

Wireless Internet service has several advantages of mobile communication, connection for at least one person at the same time, easy layout and setup, and high expandability.

As shown in FIG. 1, prior art public phone providing Wireless Internet service identified by the numeral 1 includes prior art AP identified by the numeral 2a. The prior art AP 2a connects a wired LAN segment with the wireless LAN segment via an Ethernet cable, and comprises Radio Frequency (RF) emitting antenna identified by the numeral 21a, Radio Frequency (RF) receiving antenna identified by the numeral 22a, and the module. The prior art public phone 1 uses the AP 2a as a transmission media being linked between the wired LAN (such as ADSL) and wireless product of the client. That kind of Internet communication is an expansion and completement of the conventional wired LAN, and provides mobility and connection for at least one person at the same time.

The prior art public phone 1 providing Wireless Internet service shown in FIG. 1, the housing of the AP 2a is made of plastic material, the base of the public phone 1 is made of metallic material. The housing of the AP 2a, the RF emitting antenna 21 and the RF receiving antenna 22 are neither anti-destructive material nor formed integral with the prior art public phone 1. For the reason of non stronger anti-destructive housing (such as metallic material) of the AP 2a, and the RF emitting antenna 21 and the RF receiving antenna 22 exposing out of the public phone 1, the prior art thereof is destroyed easily in practical use. Obviously the anti-destructive ability is to be improved of the structure of the prior art public phone 1.

### SUMMARY OF THE INVENTION

The object of the invention is therefore to specify a phone handset with wireless technology in applying to public telecommunications service equipment providing the anti-destructive ability of wireless telecommunication device that can overcome the above disadvantages of the prior art. Another object of the invention is to omit the manufacturing and setting steps and lower the cost by reducing the extra housing.

According to the invention, this object is achieved by a phone handset with wireless technology in applying to public telecommunications service equipment comprising a handset body and an antenna that has two ends. One end of the antenna defining an access unit positioned in an inner of the handset body, and the other end thereof defining a connecting unit positioned in a base of the public telecommunications service equipment, for example: a public phone.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

The drawings included herein provide a further understanding of the invention. A brief introduction of the drawings is as follows:

FIG. 1 is a perspective view of prior art public phone providing Wireless Internet service;

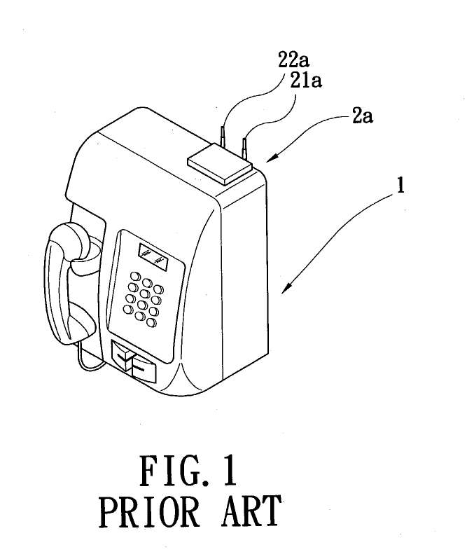

FIG. 2 is a perspective view according to one embodiment of phone handset with wireless technology;

FIG. 3 is a decomposition view according to one embodiment of phone handset with wireless technology; and

FIG. 4 is a perspective view according to another embodiment of phone handset with wireless technology.

### DETAILED DESCRIPTION OF PREFERRED EMBODIMENTS

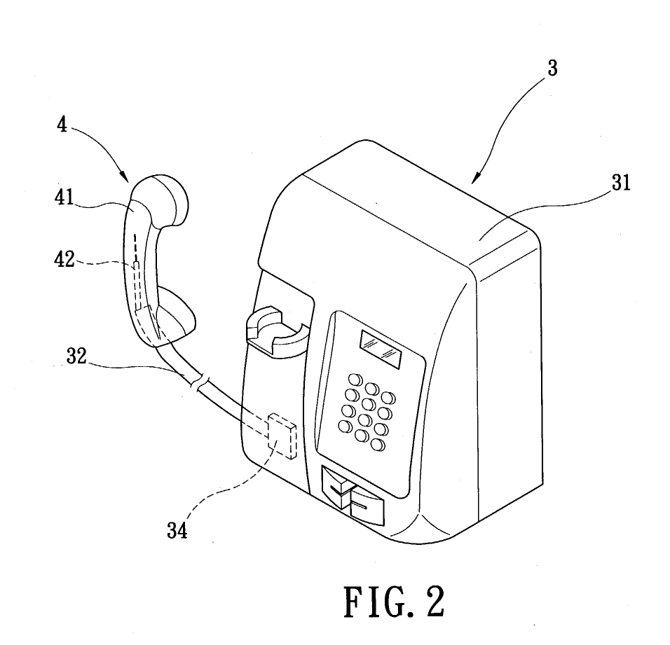

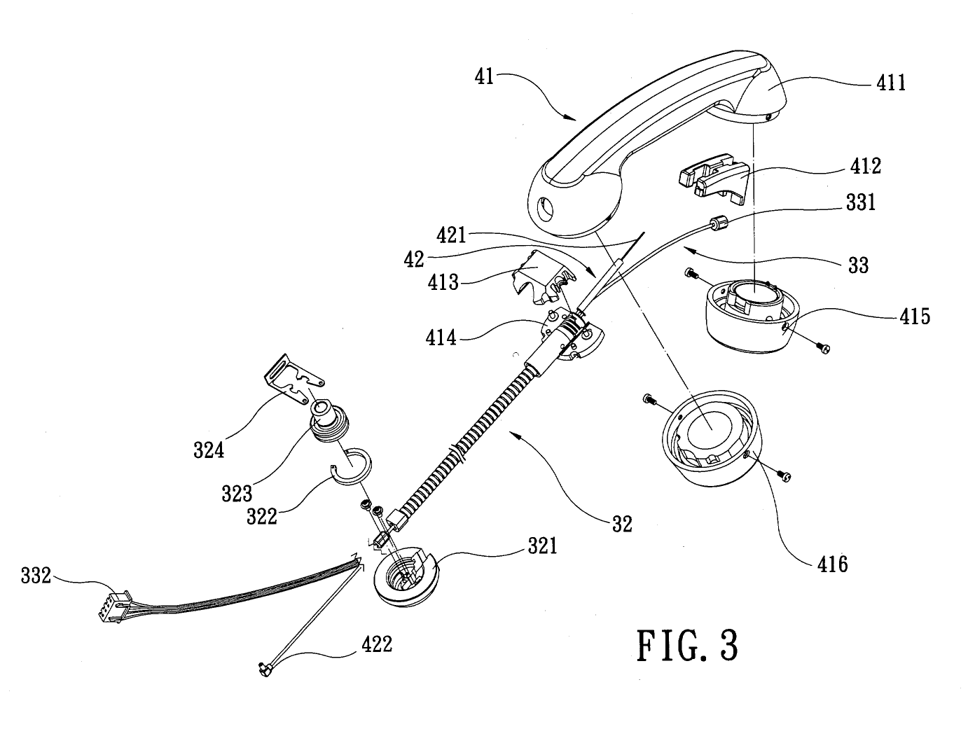

Referring to the perspective view in FIG. 2 and the decomposition view in FIG. 3 according to one embodiment of phone handset with wireless technology, the present invention provides a phone handset with wireless technology identified by the numeral 4 in applying to public phone identified by the numeral 3 comprising a handset body identified by the numeral 41 and an antenna identified by the numeral 42.

The public phone 3 includes a base identified by the numeral 31 made by metallic material, a spiral metal wire identified by the numeral 32 connecting to the base 31, a telephone line identified by the numeral 33, and a Net-switching device identified by the numeral 34. As illustrated, the Net-switching device 34 is contained in the base31, and the spiral metal wire 32 having two ends (not shown) includes a hollow recess for throughout the telephone line 33 and the antenna 42. The spiral metal wire 32 further includes a holder identified by the numeral 321, a polypropylene (PP) washer identified by the numeral 322, a revolver identified by the numeral 323, and a bolt identified by the numeral 324, whereby one of the end thereof connects to the handset body 41, the other end thereof connects to the base 31 assembled with the holder 321, the PP washer 322, the revolver 323, and the bolt 324 in regular sequence.

The handset body 41 includes a cover identified by the numeral 411, a stabilizer identified by the numeral 412, a fixing cap identified by the numeral 413, a fixing filler identified by the numeral 414, a transmitter identified by the numeral 415, and a receiver identified by the numeral 416. As illustrated in FIG. 3, the fixing filler 414, and the fixing cap 413, the fixing filler 414, which both the telephone line 33 and the antenna 42 are fixed to, and the receiver 416 are assembled to the cover 411 in regular sequence at a bottom thereof.

The telephone line 33 provides two ends, which one end defining a speaking unit identified by the numeral 331 fixed to the transmitter 415 and the other end defining a switching unit identified by the numeral 332 throughout the hollow recess of the spiral metal wire 32 to a telephone circuit (not shown) in the base 31 of the public phone 3. The stabilizer 412, the speaking unit 331, and the transmitter 415 are assembled to the cover 411in regular sequence at a top thereof.

The antenna 42 is made of metallic material and has two ends. One end of the antenna 42 defining a connecting unit identified by the numeral 422 connected to the Net-switching device 34 contained in the base 31 of the public phone 3 for transferring package information between the wireless LAN, for example: Blue Tooth, IEEE 802.11 standard, HYPERLAN and etc, and the wired LAN such as Ethernet, for example: Adaptive Digital Subscriber Line (ADSL). The other end of the antenna 42 defining an access unit identified by the numeral 421 contained in the handset body 41 for receiving and emitting signals on wireless networks. The client wireless product connects to the Internet according to the antenna 42 for detecting a signal on the wireless network and exchanges information to the wired LAN by the Net-switching device 34.

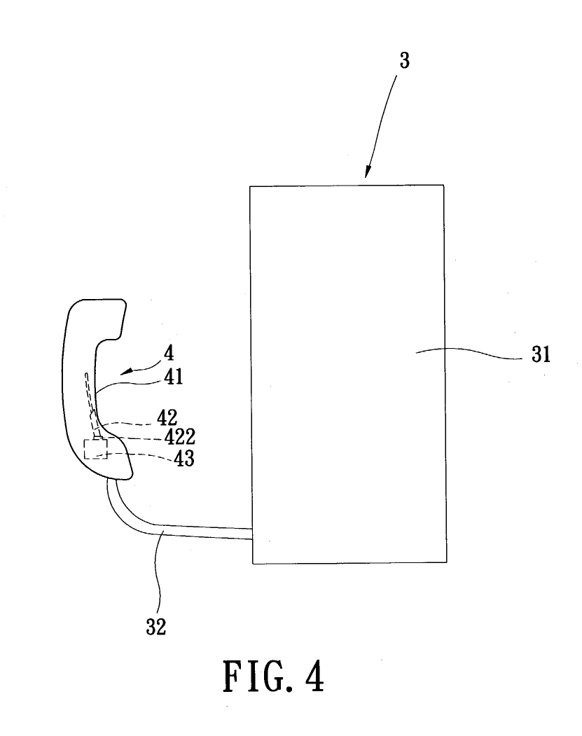

Referring to the perspective view in FIG. 4 according to another embodiment of phone handset with wireless technology, the handset body 41 is bonding to base 31 of the public phone by the spiral metal wire 32, both the access unit 421 and the connecting unit 422 of the antenna 42 are individually contained in the handset body 41, and the Net-switching device 34 is connected to the connecting unit 422 of the antenna 42.

Therefore, the object of the invention is achieved to lower the cost by reducing the extra housing and need no manufacturing and setting steps for containing the Net-switching device 34 thereof, and to improve the anti-destructive ability of wireless telecommunication device for avoiding both the Net-switching device 34 and the antenna 42 exposing out of the base 31 of the public phone 3.

The phone handset 4 with wireless technology in applying to the public phone 3 of the invention uses the AP 2a attaching to the public phone 3, and further uses the antenna of the AP 2a attaching to the handset 4 of the public phone 3. The advantages of above-mentioned invention is in advance preventing the AP 2a containing in the base 31 of the public phone of metallic material from signal-shielding, and attain the highest quality for wireless telecommunication.

Another advantage of the phone handset 4 with wireless technology, which is in applying to public telecommunications service equipment such as the public phone, or the interactive multi-media information station, is creating an understanding of agreement with the phone handset 4 providing wireless service just as antenna, and retraining users to build up the concept that the phone handset 4 is symbolic of antenna.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A phone handset with wireless technology in applying to a metallic shielding box providing Wireless Internet service for wireless products of the client, the metallic shielding box including public telecommunications service equipment having a base, a spiral metal wire and a Net-switching device; the phone handset comprising:
a handset body connected to the base of the metallic shielding box by the spiral metal wire; and
a signal-transducing unit having two ends, one end defining an access unit attached to the handset body for receiving and emitting signals on wireless networks, and the other end defining a connecting unit connected to the Net-switching device for transferring package information between the wireless local area network (LAN) and the wired LAN.

2. The phone handset with wireless technology of claim 1, wherein the public telecommunications service equipment is a public phone.

3. The phone handset with wireless technology of claim 1, wherein the public telecommunications service equipment is an emergency phone.

4. The phone handset with wireless technology of claim 1, wherein the public telecommunications service equipment is an interactive multi-media information station.

5. The phone handset with wireless technology of claim 1, wherein the access unit of the signal-transducing unit is contained in the handset body.

6. The phone handset with wireless technology of claim 1, wherein the connecting unit of the signal-transducing unit is contained in the base of the metallic shielding box.

7. The phone handset with wireless technology of claim 1, wherein the connecting unit of the signal-transducing unit is contained in the handset body.

8. The phone handset with wireless technology of claim 1, wherein the signal-transducing unit is an antenna.
